(19) United States
(12) Patent Application Publication
(10) Pub. No.: US 2009/0133655 A1
(43) Pub. Date: May 28, 2009

(54) LASER IGNITION SYSTEM

(75) Inventors: Takayuki Inohara, Okazaki-city (JP); Akihiro Ando, Okazaki-city (JP); Naoki Kido, Okazaki-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/264,280

(22) Filed: Nov. 4, 2008

(30) Foreign Application Priority Data
Nov. 27, 2007 (JP) 2007-305743

(51) Int. Cl. F02P 23/04

(52) U.S. Cl. 123/143 B

(57) ABSTRACT

A laser ignition system includes a laser oscillator and an oscillation controller. The laser oscillator is configured to generate laser light into a combustion chamber of an engine. The oscillation controller is configured to cause the laser oscillator to generate a plurality of laser pulses into the combustion chamber in order to ignite the engine. The oscillation controller causes the laser oscillator to generate each of the plurality of laser pulses at a laser oscillation period that is longer than 10 μs and shorter than 300 μs.

### CROSS REFERENCE TO RELATED APPLICATION

This application is based on and incorporates herein by reference Japanese Patent Application No. 2007-305743 filed on Nov. 27, 2007.

### BACKGROUND OF THE INVENTION

1. Field of the Invention

The present invention relates to the improvement of ignitability of a laser ignition system used for igniting an internal combustion engine, and relates to reduction of the laser ignition system in size.

2. Description of Related Art

Recently, in an internal combustion engine for vehicles, there has been needs for further improvement of fuel efficiency and leaner burn in order to reduce environmental load substances, such as nitrogen oxides, carbon monoxide, in combustion exhaust gas.

There has been paid attention to a method for effectively causing combustion of lean air-fuel mixture by emitting laser light into a combustion chamber of the engine. In general, flame formed by a conventional ignition plug is limited from spreading in the above lean air-fuel mixture. The above method for the engine achieves both the improvement of efficiency of combustion for the engine and the reduction in environmental load.

As the above engine, JP-A-2002-295256 describes a premixed compression ignition engine, in which ignition ultraviolet rays are applied to high-temperature premixed air-fuel mixture in the cylinder during the end of compression stroke in order to directly generate radical in the premixed air-fuel mixture, thereby inducing the ignition.

JP-A-2005-42591 describes a laser ignition engine and an operation method of the same, which engine includes a laser generation apparatus and a laser converging apparatus. The laser light, which is emitted by the laser generation apparatus, is transmitted to the laser converging apparatus such that the laser light is applied into the combustion chamber for generating plasma. The generated plasma ignites gas in the combustion chamber. The above laser ignition engine is characterized by laser light oscillation control means for causing the laser generation apparatus to generate multiple laser pulses at a pulse interval that enables a laser normal ignition in the combustion chamber.

The method of JP-A-2002-295256 requires high energy of 35 mJ as shown in FIG. 2 of JP-A-2002-295256, and thereby the increase in size of the apparatus and the increase in cost may be caused.

Also, although the method of JP-A-2005-42591 is capable of emitting multiple laser pulses such that the energy per 1 pulse may be reduced to be in a range of several mJ to a dozen or so 10 mJ, the method requires oscillation or generation of the laser light at substantially short pulse intervals of equal to or smaller than 10 μs (or 8 μs). However, in order to charge the laser generation source with substantial energy for generating the laser light at the above short pulse intervals, substantially large electric current is required to be fed to a single laser generation source. Otherwise, multiple laser generation sources are required. As above, the laser ignition system requires larger electric current, and is increased in size.

Therefore, the conventional laser ignition system may be difficult to be mounted on an engine room of recent vehicles that are substantially highly integrated.

### SUMMARY OF THE INVENTION

The present invention is made in view of the above disadvantages. Thus, it is an objective of the present invention to address at least one of the above disadvantages.

To achieve the objective of the present invention, there is provided a laser ignition system, which includes a laser oscillator and an oscillation controller. The laser oscillator is configured to generate laser light into a combustion chamber of an engine. The oscillation controller is configured to cause the laser oscillator to generate a plurality of laser pulses into the combustion chamber in order to ignite the engine. The oscillation controller causes the laser oscillator to generate each of the plurality of laser pulses at a laser oscillation period that is longer than 10 μs and shorter than 300 μs.

### BRIEF DESCRIPTION OF THE DRAWINGS

The invention, together with additional objectives, features and advantages thereof, will be best understood from the following description, the appended claims and the accompanying drawings in which:

FIG. 1 is a general diagram illustrating a configuration of a laser ignition system of one embodiment of the present invention;

FIG. 2 is a schematic diagram of an example configuration of a laser oscillator applicable to the laser ignition system of the one embodiment of the present invention;

FIG. 3 is a schematic diagram illustrating an example configuration of another laser oscillator applicable to the laser ignition system of the one embodiment of the present invention;

FIG. 4A is a characteristic diagram illustrating a flame kernel cross sectional area and a flame kernel turbulence relative to a laser oscillation period;

FIG. 4B is a characteristic diagram showing an initial combustion time relative to the oscillation period according to the one embodiment of the present invention;

FIG. 5A is a characteristic diagram illustrating a cylinder pressure and a combustion ratio relative to a crank angle according to the one embodiment of the present invention and a comparison example;

FIG. 5B is a characteristic diagram showing an advantage of the one embodiment compared with the comparison example during an initial combustion and a main combustion;

FIG. 6A is a characteristic diagram illustrating an indicated mean effective pressure according to the comparison example;

FIG. 6B is a characteristic diagram illustrating an indicated mean effective pressure according to the one embodiment of the present invention;

FIG. 6C is a characteristic diagram illustrating an advantage with respect to a combustion change of the one embodiment of the present invention relative to the comparison example; and

FIG. 7 is a flow chart illustrating an example configuration of an oscillation controller applicable to the laser ignition system of the one embodiment of the present invention.

### DETAILED DESCRIPTION OF PREFERRED EMBODIMENTS

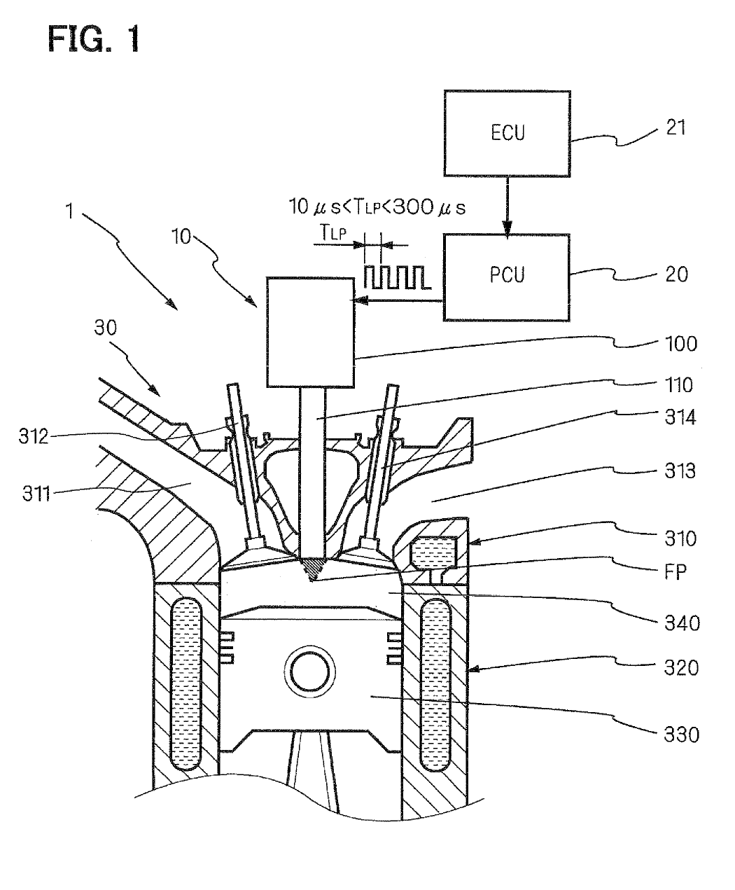

A laser ignition system 1 of one embodiment of the present invention will be described with reference to FIG. 1.

The laser ignition system 1 includes an internal combustion engine 30, a laser oscillator 10, an oscillation controller (PCU) 20, and an electronic control device (ECU) 21. The PCU 20 performs an oscillation control of the laser oscillator 10. In other words, the PCU 20 causes the laser oscillator 10 to generate laser pulses. The ECU 21 controls the PCU 20 and performs a combustion control of the internal combustion engine.

The internal combustion engine 30 includes a cylinder head 310, a cylinder 320, and a piston 330. A combustion chamber 340 is defined by an inner wall of the cylinder head 310, a radially inner wall of the cylinder 320, and an upper surface of the piston 330.

The cylinder head 310 is provided with an intake pipe 311 and an exhaust pipe 313. An intake valve 312 and an exhaust valve 314 enable and disable communication between the combustion chamber 340 and each of the pipes 311, 313, respectively.

The laser oscillator 10 includes a laser oscillating portion 100 and a light converging portion 110.

The light converging portion 110 converges laser light generated or oscillated by the laser oscillating portion 100 on a light convergent spot FP of the combustion chamber 340.

The laser oscillator 10 generates the laser light at laser oscillation periods T_{LP}. In other words, the laser oscillator 10 generates each of multiple laser pulses at the laser oscillation period T_{LP} (or a pulse interval T_{LP}). The PCU 20 changes the laser oscillation periods T_{LP} in a range longer than 10 μs and shorter than 300 μs based on an operational state of the internal combustion engine 30.

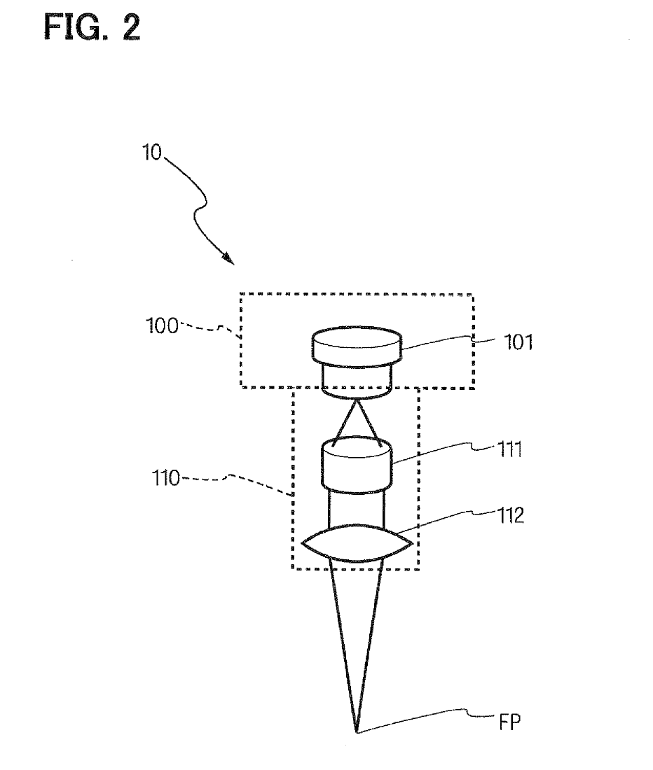

FIG. 2 shows an example of the laser oscillator 10 applicable to the laser ignition system 1 of the one embodiment of the present invention. In the present embodiment, the laser oscillating portion 100 is provided with a semiconductor laser 101 of, for example, a can-package type, and the light converging portion 110 includes a collimate lens (group lens) 111 and a converging lens 112. The light converging portion 110 directly converges the laser light generated by the semiconductor laser 101 on the light convergent spot FP inside the combustion chamber 340.

In the present embodiment, the laser oscillation period T_{LP} and oscillation energy for the laser light generated by the semiconductor laser 101 are controlled based on an electric current fed to the semiconductor laser 101.

It should be noted that in the present embodiment a transmission line, such as an optical fiber, for transmitting laser light may be provided between the semiconductor laser 101 and the collimate lens 111 such that the laser oscillating portion 100 may be provided as a separate body separate from the light converging portion 110.

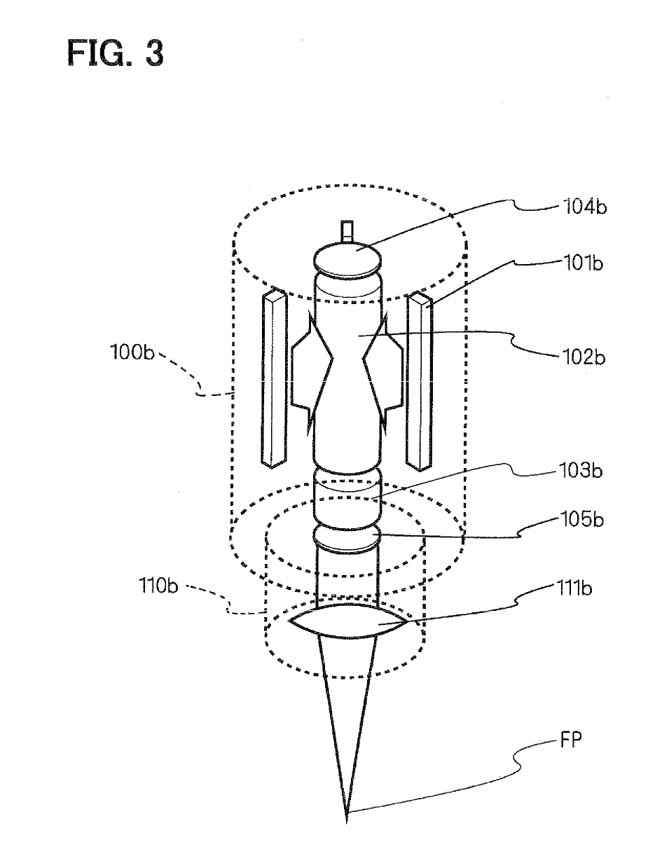

FIG. 3 shows a laser oscillator 10b as another example of the laser oscillator applicable to the laser ignition system 1 of the one embodiment of the present invention. In the present embodiment, a laser oscillating portion 100b of the laser oscillator 10b includes, for example, an excitation semiconductor laser 101b of a bar type, a solid laser 102b, a shutter element 103b (Q switch), a reflecting mirror 104b, and an output mirror 105b. The solid laser 102b is excited by the laser light generated by the excitation semiconductor laser 101b.

The laser light generated by the excitation semiconductor laser 101b excites both the solid laser 102b and the shutter element 103b, and at a very moment when the energy inside the shutter element 103b exceeds a certain threshold value, which is determined by physical properties of the shutter element 103b, a shutter is opened. In other words, when the energy inside the shutter element 103b exceeds the certain threshold value, the shutter element 103b becomes transparent relative to the laser light generated by the solid laser 102b. Due to the above configuration, the laser light resonates every time the laser light reciprocally travels between the reflecting mirror 104b and the output mirror 105b to be amplified while the shutter is closed. As a result, thus amplified laser light having a high energy density is instantly obtainable when the shutter is open.

A light converging portion 110b of the laser oscillator 10b includes a converging lens 112b and converges laser light emitted through the output mirror 105b into the light convergent spot FP in the combustion chamber 340.

In the present embodiment, the laser oscillation period and the oscillation energy of the laser light generated by the solid laser 102b are controlled by an electric current fed to the excitation semiconductor laser 101b, or are controlled based on characteristics of a light emitting element of the solid laser 102b or characteristics of the shutter element 103b.

It should be noted that although the present embodiment shows the laser oscillating portion 100b that applies excitation laser light toward a lateral surface of the solid laser 102b, another laser oscillating portion that applies excitation laser light to a longitudinal end surface of the solid laser 102b may be alternatively employed.

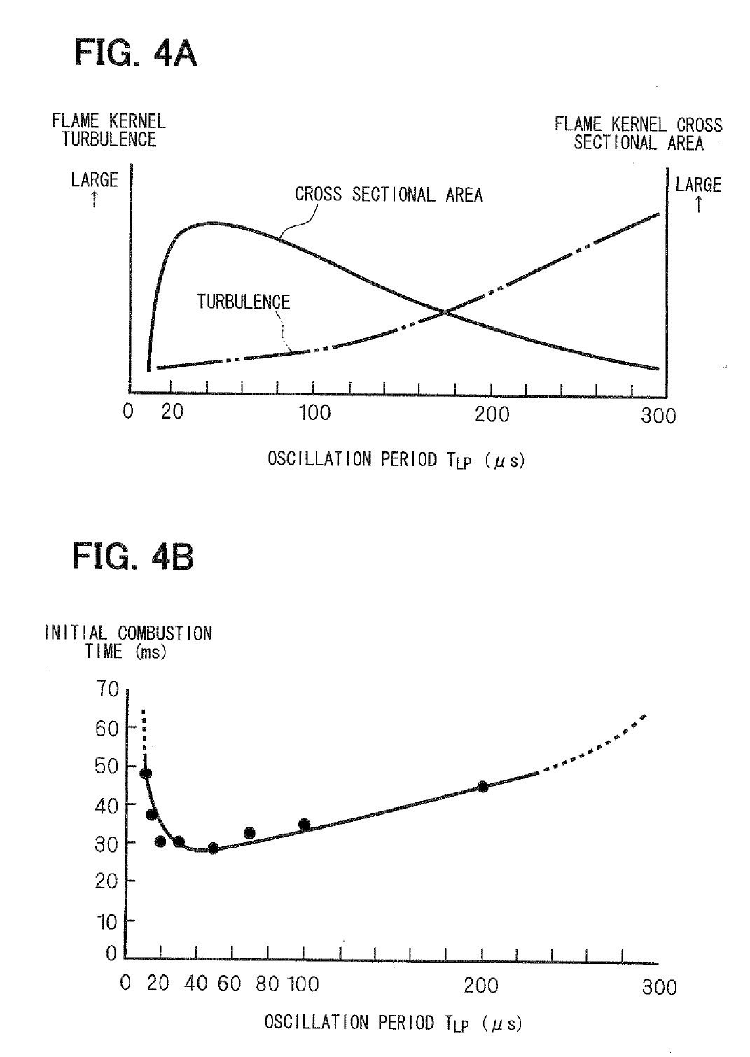

Advantages of the present invention will be described with reference to FIG. 4.

The inventors have conducted extensive study and have found that there is a relation shown in FIG. 4A of a cross sectional area of a flame kernel and turbulence of the flame kernel relative to the laser oscillation period of the laser light.

In the present examination, ignition is attempted by converging laser light on a light convergent spot at a predetermined position in a certain container. The certain container serves as a mimicking gasoline engine having a certain volume, and is filled with a propane and air that are mixed by a certain ratio (equivalent ratio 0.9). In the present examination, in order to study the change of flame kernel, the laser oscillation period T_{LP} is changed in a case, where four laser pulses having energy of 7 mJ per one pulse generation are generated.

The followings are found in the above examination. When the laser oscillation period T_{LP} is changed in a range of 10 μs to 300 μs, the cross sectional area of the flame kernel is gradually increased as the laser oscillation period T_{LP} becomes longer until the cross sectional area reaches a peak at the laser oscillation period T_{LP} of several tens is. Then, as the laser oscillation period T_{LP} becomes further longer, the cross sectional area is gradually reduced.

The turbulence of the flame kernel, in other words, a surface area of the flame kernel, is increased as the laser oscillation period T_{LP} becomes longer.

FIG. 4B shows an initial combustion time in the present examination relative to the oscillation period. The initial combustion time is measured between (a) timing of a laser ignition and (b) timing, at which a combustion ratio reaches 10%. Although the mixture of the same air-fuel ratio is attempted to be ignited using a normal spark plug for comparison, combustion is not successfully made because the air-fuel ratio is substantially lean.

As shown in FIG. 4B, it is found that substantially lean mixture for a combustion engine is able to be ignited in a case, where the laser oscillation period T_{LP} is in a range longer than 10 μs and shorter than 300 μs.

It is found that it is difficult to generate laser pulses at the laser oscillation periods T_{LP} of equal to or less than 10 μs by a single laser oscillator, and that the initial combustion time becomes longer in the above laser oscillation periods T_{LP}. Also, when the laser oscillation period T_{LP} is set equal to or greater than 300 as, a flame-out effect for extinguishing the flame, which effect is caused by turbulence of flame kernel, outperforms a combustion facilitation effect for facilitating the combustion, which effect is caused by the forming of the flame kernel, and thereby the ignition is not successfully made.

It is found that by setting the laser oscillation period T_{LP} equal to or greater than 20 μs and equal to or less than 100 μs, the initial combustion is substantially enhanced or is more rapidly made. Also, the initial combustion is most rapidly made at the laser oscillation period T_{LP} that corresponds to the maximum flame kernel cross sectional area.

Based on the above examination result, the inventors found the followings. (1) The laser oscillation generates flame kernel in the air-fuel mixture, and the further growth of the flame kernel causes the combustion in the engine. However, further application of the multiple laser pulses during the growth of the flame kernel may cause turbulence in the flame kernel in addition to causing the growth of the flame kernel. (2) The turbulence of flame kernel becomes greater as the laser oscillation period T_{LP} is made longer. (3) The turbulence of flame kernel facilitates the growth of the flame kernel. However, the turbulence of flame kernel also increases a surface area of the flame kernel, and thereby the flame kernel is more easily cooled by the air-fuel mixture as the surface area increases. (4) In other words, the increase of turbulence of flame kernel causes mutually opposing effects, that is facilitation and flame-out of the combustion. (5) Thus, when the laser ignition system is operated under a specific laser oscillation period T_{LP} (longer than 10 μs and shorter than 300 μs, for example), facilitation and flame-out of the combustion are balanced out, and thereby reliable combustion is attainable quickly.

In the present embodiment, the laser oscillation period T_{LP} is set substantially longer than a charge period required to charge the energy to generate the laser. As a result, without increasing the electric current amount and the number of the laser oscillator, a single laser oscillator 10, 10b is capable of generating required multiple laser pulses. Thus, the reduction of the laser ignition system in size is achieved.

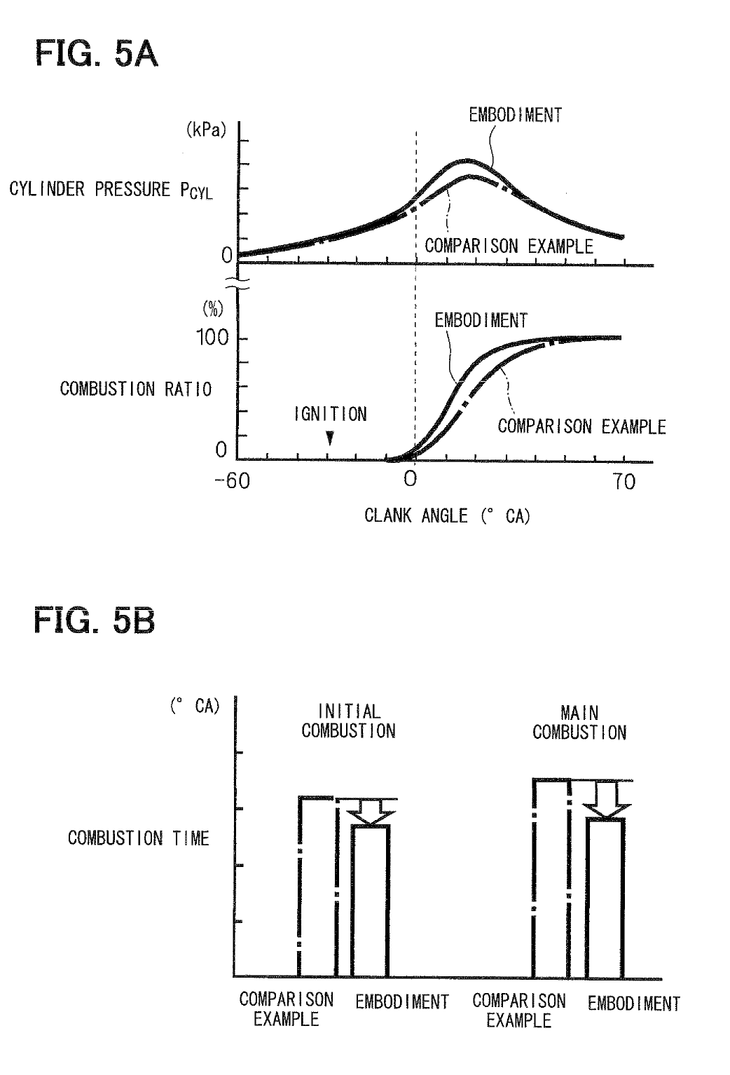

FIGS. 5A and 5B show results of performance of an actual gasoline engine, to which the present embodiment is applied.

In the present examination, ignition by the laser ignition system of the present embodiment is made by generating the multiple laser pulses at fixed laser oscillation periods of 50 μs. Also, ignition is attempted using a normal spark plug in a comparison example.

As shown in FIG. 5A, the present embodiment shows quicker rise or more sharp rise in a cylinder pressure P_{CYL} than a cylinder pressure P_{CYL} of the comparison example. Also, a speed of a change of a combustion ratio for the present embodiment is faster than the comparison example. As shown in FIG. 5B, the present embodiment shows a shorter initial combustion time and a shorter main combustion time than the comparison example. In the above, the initial combustion time is defined by a crank angle measured between (a) timing of the ignition and (b) timing, at which the combustion ratio reaches 10%. Also, the main combustion time is defined by a crank angle measured between (a) timing, at which the combustion ratio reaches 10% and (b) timing, at which the combustion ratio reaches 90%. As above, the combustion is stabilized earlier in the present embodiment than the comparison example.

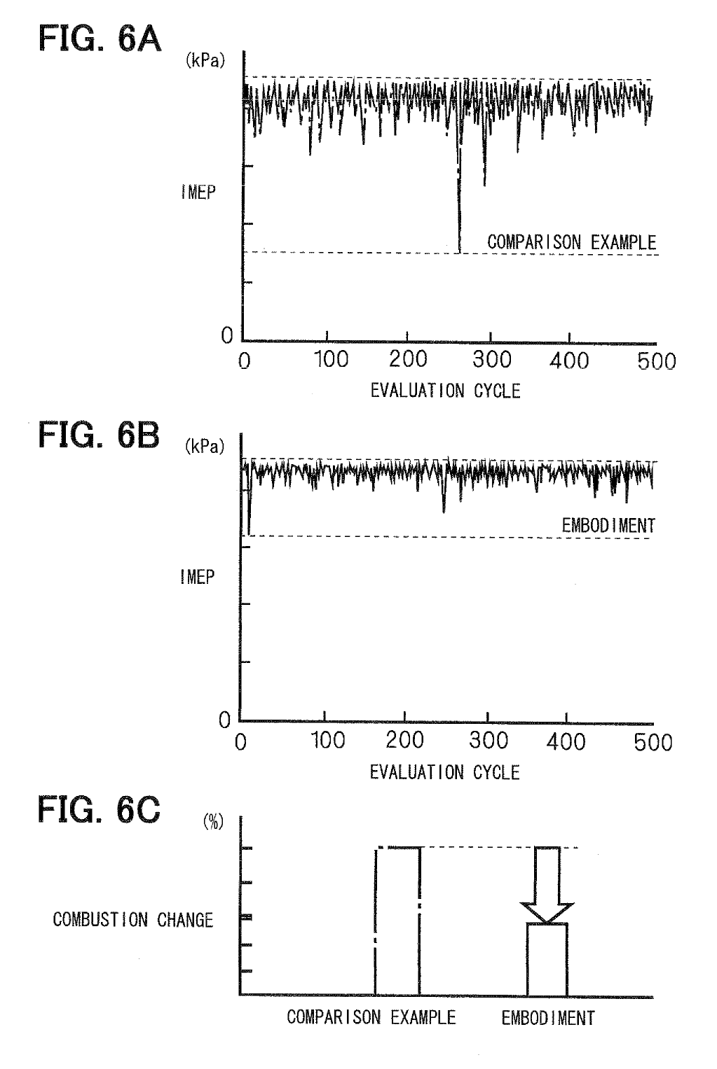

Further, FIGS. 6A to 6C show indicated mean effective pressures or IMEP (kPa) and a combustion change (%), which is defined by dividing a standard deviation of the indicated mean effective pressure by an average value of indicated mean effective pressure.

FIG. 6A shows the indicated mean effective pressure of 500 cycles in series according to the comparison example, and FIG. 6B shows the indicated mean effective pressure of 500 cycles in series according to the present embodiment. FIG. 6C shows an advantage in a combustion change of the present embodiment compared with the comparison example.

According to the present embodiment, variation of the indicated mean effective pressure is smaller, and the combustion change is substantially reduced compared with the conventional art. Thereby, reliable ignition is achieved.

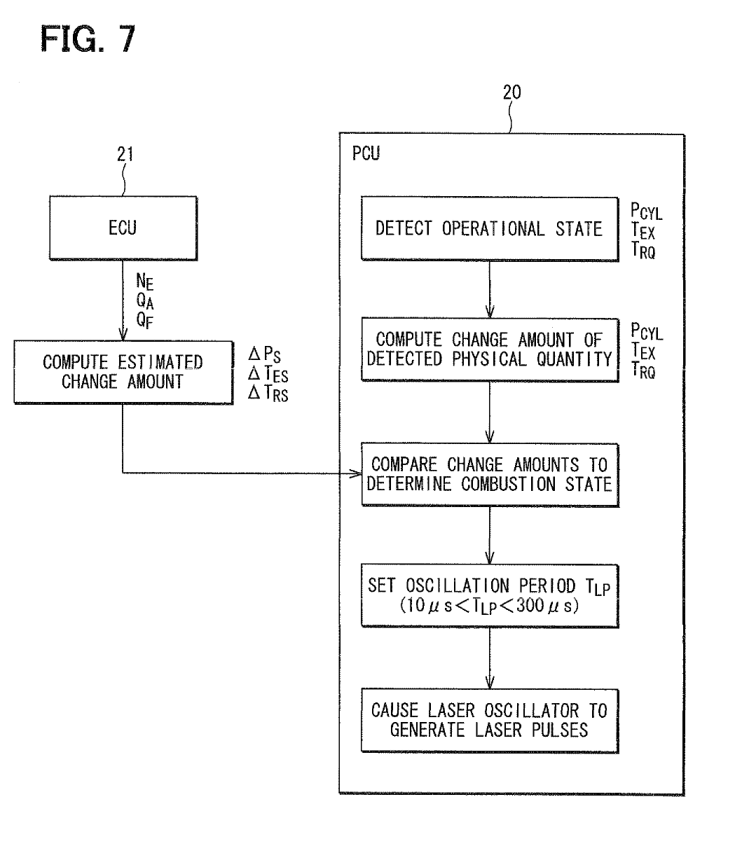

FIG. 7 shows one example of a control flow of the PCU 20 applicable to the one embodiment of the present invention.

For example, the PCU 20 includes a pressure sensor, an exhaust gas temperature sensor, and a torque sensor as operational state detecting means for detecting an operational state of the internal combustion engine 30. More specifically, for example, the pressure sensor senses a cylinder pressure P_{CYL}, and the exhaust gas temperature sensor senses an exhaust gas temperature T_{EX}. The torque sensor senses an output torque T_{RQ}. Physical quantity, such as P_{CYL}, T_{EX}, T_{RQ}, which is detected by the above detecting means is monitored, and an average value of the physical quantity is computed. A change amount, such as ΔP_{CYL}, ΔT_{EX}, ΔT_{RQ}, is computed by dividing a standard deviation of each physical quantity by the above computed average value.

Also, the PCU 20 may alternatively include laser oscillation period changing means. An estimated change amount (ΔP_{S}, ΔT_{ES}, ΔT_{RS}) for the physical quantity, such as a cylinder pressure, an exhaust gas temperature, and an output torque, is estimated based on a control change amount obtained from information sets from the ECU 211 such as an engine rotational speed N_{E}, an air amount Q_{A}, a fuel injection quantity Q_{F}. The laser oscillation period changing means compares the above change amount (ΔP_{CYL}, ΔT_{EX}, ΔT_{RQ}) with the estimated change amount (ΔP_{S}, ΔT_{ES}, ΔT_{RS}) for determining a combustion state. Then, the oscillation period changing means changes the laser oscillation period T_{LP} based on the above determined combustion state. In the above case, the laser oscillation period T_{LP} is set longer than 10 μs and shorter than 300 μs such that the combustion state of the engine is effectively established.

According to the above configuration, the laser oscillation period T_{LP} is able to be change to a certain period based on the actual operational state of the engine in order to achieve an improved ignitability. As a result, the reliability of the laser ignition system 1 is further improved.

It should be noted that although the above examination employs the laser ignition system that generates four laser pulses having energy of 7 mJ per 1 pulse generation, the present invention is not limited to the above oscillation energy and the above pulse generation. Provided that the gist of the present invention, in which the laser pulses are generated at predetermined laser oscillation periods, is not deviated, a size of the applied engine and a type of fuel engine are changeable according to the operational state of the engine.

Additional advantages and modifications will readily occur to those skilled in the art. The invention in its broader terms is therefore not limited to the specific details, representative apparatus, and illustrative examples shown and described.

What is claimed is:

1. A laser ignition system comprising:
a laser oscillator that is configured to generate laser light into a combustion chamber of an engine; and
an oscillation controller that is configured to cause the laser oscillator to generate a plurality of laser pulses into the combustion chamber in order to ignite the engine, wherein:
the oscillation controller causes the laser oscillator to generate each of the plurality of laser pulses at a laser oscillation period that is longer than 10 μs and shorter than 300 μs.

2. The laser ignition system according to claim 1, wherein:
the laser oscillation period is equal to or greater than 20 μs and is equal to or less than 100 μs.

3. The laser ignition system according to claim 1, wherein:
the laser oscillator includes a laser oscillating portion and a light converging portion;
the light converging portion converges laser light generated by the laser oscillating portion into the combustion chamber of the engine; and
the light converging portion is at least mounted on the engine.

4. The laser ignition system according to claim 2, wherein:
the laser oscillating portion includes a semiconductor laser; and
the semiconductor laser directly generates laser light.

5. The laser ignition system according to claim 2, wherein:
the laser oscillating portion includes semiconductor laser and a solid laser that is excited by the semiconductor laser, and
the solid laser generates laser light.

6. The laser ignition system according to claim 1, wherein the oscillation controller includes:
operational state detecting means for detecting an operational state of the engine; and
oscillation period changing means for changing the laser oscillation period based on the operational state detected by the operational state detecting means.
